(19) United States
(12) Patent Application Publication
(10) Pub. No.: US 2014/0071139 A1
(43) Pub. Date: Mar. 13, 2014

(54) IMOD PIXEL ARCHITECTURE FOR IMPROVED FILL FACTOR, FRAME RATE AND STICTION PERFORMANCE

(71) Applicants: Kostadin D. Djordjev, San Jose, CA (US); Alok Govil, Santa Clara, CA (US); Yi Tao, San Jose, CA (US); Fan Zhong, Fremont, CA (US)

(72) Inventors: Kostadin D. Djordjev, San Jose, CA (US); Alok Govil, Santa Clara, CA (US); Yi Tao, San Jose, CA (US); Fan Zhong, Fremont, CA (US)

(73) Assignee: QUALCOMM MEMS TECHNOLOGIES, INC., San Diego, CA (US)

(21) Appl. No.: 13/614,973

(22) Filed: Sep. 13, 2012

(51) Int. Cl. G06T 1/00; B05D 5/12; G02B 26/00; B05D 5/06

(52) U.S. Cl. 345/501; 427/58; 359/291

(57) ABSTRACT

Pixels that include display elements that are configured with different structural dimensions corresponding to the color of light they provide are disclosed. In one implementation, a display device includes an array having a plurality of electromechanical pixels disposed on a substrate, each pixel including at least a first display element and a second display element. Each of the first and second display elements interferometrically modulating light by moving a reflective element between a relaxed position spaced apart from the substrate to an actuated position further away from the substrate than the relaxed position by applying a voltage across the reflective element and a stationary electrode. The stationary electrode of each display element is sized to provide actuation of the movable reflective element using the same actuation voltage even though the electrical gap through which the reflective element moves is different within a pixel.

### TECHNICAL FIELD

This disclosure relates to interferometric modulators. More specifically, this disclosure relates to interferometric modulator display elements of pixels in a display having various interferometric gap and electrode dimensions.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical display device. The device can include an array having a plurality of electromechanical pixels, each pixel including a first display element having a first optical stack including a partially transmissive absorbing layer disposed on a substrate, a first reflective movable layer disposed over the optical stack and separated from the optical stack by an optical gap of height H₁ when the first reflective movable layer is in a relaxed state, and a first top electrode disposed above the first movable layer and separated from the first optical stack by an electrical gap having a height. H₂, the movable layer disposed between the substrate the first electrode, the first movable layer movable between a relaxed state and an actuated state by applying a voltage across the first movable layer and the first electrode. Each pixel further includes a second display element having a second optical stack including a partially transmissive absorbing layer disposed on a substrate, a second reflective movable layer disposed over the second optical stack and separated from the second optical stack by an optical gap of height H₃ when the second reflective movable layer is in a relaxed state, and a second electrode disposed above the second movable layer and separated from the second optical stack by an electrical gap of height H₄ different than the height H₂, the second movable layer movable between a relaxed state and an actuated state by applying a voltage across the second movable layer and the second electrode.

The various implementations of the innovations described herein can include other features and aspects. For example, in one aspect, in the relaxed state the first movable layer achieves a reflective dark state, in the actuated state the first movable layer is moved towards the first electrode to a position to reflect light of a first spectrum of wavelengths, in the relaxed state the second movable layer achieves a reflective dark state, and in the actuated state the second movable layer is moved towards the second electrode to a position to reflect a second spectrum of wavelengths. In another aspect, the first spectrum of wavelengths is different than the second spectrum of wavelengths. In another aspect, the first spectrum of wavelengths corresponds to a first color and the second spectrum of wavelengths corresponds to a second color. In another aspect, the surface area of the first electrode is smaller than the surface area of the second electrode. In another aspect, the height H₂ is greater than the height H₄. In another aspect, the first electrode has a different shape than the second electrode. In another aspect, the height H₁ and the height H₃ are substantially the same. In another aspect, at least a respective portion of at least one of the first and second electrodes includes anti-stiction bumps or anti-stiction dimples. In another aspect, each of the first and second optical stacks include a light absorbing layer having a thickness dimension of less than 10 nm and an etch stop layer having a thickness of less than 10 nm, the etch stop layer being disposed between the light absorbing layer and optical gap of the first display element, and also between the light absorbing layer and the optical gap of the second display element. In another aspect, the light absorbing layer includes molybdenum-chromium (MoCr). In another aspect, the etch-stop layer includes aluminum oxide (AlOx). In another aspect, heights H₁ and H₃ are between about 70 nm and 130 nm. In another aspect, the optical gap of height H₁ has a height between about 90 nm and 110 nm.

A display device can further include a third display element having a third optical stack including a partially transmissive absorbing layer disposed on a substrate, a third reflective movable layer disposed over the third optical stack and separated from the third optical stack by an optical gap of height H₅ when the third reflective movable layer is in a relaxed state, a third electrode disposed above the third movable layer and separated from the third optical stack by an electrical gap of height H₆ which is different than the height H₂ and the height H₄, the third movable layer movable between a relaxed state and an actuated state by applying a voltage across the third movable layer and the third electrode. The device is configured such that in the relaxed state the third movable layer achieves a reflective dark state, and in the actuated state the third movable layer is moved towards the third electrode to a position to reflect a third color. In one aspect, the first and second display elements are interferometric modulators. In some implementations, the device can further include a display, wherein the display includes an array of the first display element and second display element, a processor that is configured to communicate with the display, the processor being configured to process image data, and a memory device that is configured to communicate with the processor.

The device can further include a driver circuit configured to send at least one signal to the display. The device can further include a controller configured to send at least a portion of the image data to the driver circuit. The device can further include an image source module configured to send the image data to the processor. The device can further include an input device configured to receive input data and to communicate the input data to the processor.

In another innovative aspect, a display device includes an array having a plurality of electromechanical pixels disposed on a substrate, each pixel including at least a first display element and a second display element, each of the first and second display elements including means for interferometrically modulating light by moving a reflective element between a relaxed position spaced apart from the substrate by between 70 nm and 130 nm to an actuated position further away from an optical stack disposed on the substrate than the relaxed position by applying a voltage across the reflective element and a stationary electrode, where the modulating light means achieves a reflective dark state when the reflective element is in the relaxed position and achieves a reflective color state when the reflective element is in the actuated position. In some implementations, the first display element includes a first optical stack including a partially transmissive absorbing layer disposed on a substrate, a first reflective movable layer disposed over the optical stack and separated from the optical stack by an optical gap of height H₁ when the first reflective movable layer is in a relaxed state, a first electrode disposed above the first movable layer and separated from the first optical stack by an electrical gap of height H₂, the first movable layer movable between a relaxed state and an actuated state by applying a voltage across the first movable layer and the first electrode. In the relaxed state the first movable layer achieves a reflective dark state, and in the actuated state the first movable layer is moved towards the first electrode to a position to reflect a first color. The second display element includes a second optical stack including a partially transmissive absorbing layer disposed on a substrate, a second reflective movable layer disposed over the second optical stack and separated from the second optical stack by an optical gap of height H₃ when the second reflective movable layer is in a relaxed state, and a second electrode disposed above the second movable layer and separated from the second optical stack by an electrical gap of height H₄ different than the height H₂, the second movable layer movable between a relaxed state and an actuated state by applying a voltage across the second movable layer and the second electrode. In the relaxed state the second movable layer achieves a reflective dark state, and in the actuated state the second movable layer is moved towards the second electrode to a position to reflect a second color. In some implementations the device may include other various aspects. For example, in one aspect at least a respective portion of the first and second electrodes includes anti-stiction bumps or anti-stiction dimples. In another aspect, each of the first and second optical stacks include a light absorbing layer having a thickness dimension of less than 10 nm and an etch stop layer having a thickness of less than 10 nm, the etch stop layer being disposed between the light absorbing layer and the optical gap of height H₁. In another aspect, the light absorbing layer includes molybdenum-chromium (MoCr). In another aspect, the etch-stop layer includes aluminum oxide (AlOx).

In another innovative aspect, a method of forming at least two display elements of a pixel of an electromechanical display apparatus includes forming an optical stack on a substrate, the optical stack including an absorbing layer having a thickness of less than 10 nm, and an etch-stop layer having a thickness of less than 10 nm, forming a first sacrificial layer over the optical stack to define the height of an optical gap associated with a first display element and an optical gap associated with a second display element, forming supports for a movable reflective layer, forming a reflective layer over the first sacrificial layer, forming a second sacrificial layer over the reflective layer to define the height of an electrical gap associated with the first display element, and forming a third sacrificial layer to define the height of an electrical gap associated with the second display element, forming an electrode structure over the second sacrificial layer, forming an electrode structure over the third sacrificial layer, removing the first sacrificial layer to form the optical gap in the first display element and the optical gap in the second display element, the first and second gaps defining the position of the reflective layer of the first and second display element when the reflective layer is in a relaxed state, and removing the second and third sacrificial layers to form the electrical gaps associated with the first and second display elements respectively. In the relaxed state the optical gaps may have a height dimension of between 70 nm and 130 nm. The method may further include forming anti-stiction bumps or dimples on the electrode structure on a portion of the electrode structure proximate to the reflective element. In some implementations, the surface area of the electrode structure formed over the third sacrificial layer is larger than the surface area of the electrode structure formed over the second sacrificial layer. The method may further include patterning the shape of the electrode structure formed over the third sacrificial layer to be different than the shape of the electrode formed over the second sacrificial layer.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a cross-sectional schematic illustrating a portion of a display that includes a pixel having display elements that are configured with different structural dimensions corresponding to the color of light they provide.

FIG. 10 shows an example of a plan view schematic illustrating different electrode dimensions for IMOD display elements in a pixel.

FIG. 11 is a graph illustrating simulation results that indicate actuation voltages based on a radius of a top electrode cut and dielectric mechanical layer thickness for red, blue, and green implementations of interferometric modulator display elements.

FIGS. 12A and 12B show an example of a flow diagram illustrating a manufacturing process for an interferometric modulator.

FIGS. 13A-13N show examples of cross-sectional schematic illustrations of various stages in a method of making an interferometric modulator.

FIGS. 14A and 14B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations of MEMS devices, a pixel design can have at least two display elements (also referred to as sub-pixels) that are configured to improve an fill factor and frame rate, and to reduce stiction. In one implementation, such a pixel can include a substrate and an absorber layer disposed thereon. The pixel is configured to be viewed from the substrate side, through the substrate. In some implementations, the pixel can include three two-terminal two-state electromechanical display devices where the electrical and optical gaps are separated In other words, the optical gap is between the absorbing layer and a movable reflective layer which also functions as an electrode. The electrical gap is between the movable reflective layer and a top electrode disposed on the opposite side of the movable layer as the substrate such that the movable layer is disposed between the substrate and the top electrode. This device is viewed through the substrate. The absorber layer can include molybdenum-chromium (MoCr), molybdenum (Mo), chromium (Cr), or vanadium (V). In this implementation, the absorber layer is not used as a driving electrode. The absorber layer can be covered by a thin AlOx layer to protect the absorber layer from the release etch. In this implementation, actuation of the pixel display elements moves the (movable) reflective layer away from the substrate toward the top electrode.

The display elements can be configured such that in an unactuated state, the reflective movable layer is substantially level and positioned such that the display element is in a black state (appears black when viewed through the substrate). The black state may be affected by, for example, the height dimension of the optical gap, the thickness of the absorber layer, and materials used in the optical stack including the absorber layer. In this implementation, the optical stack is designed in such a way that in the undriven state, which is also referred to as the “unactuated state” or the “release state”) state the pixel is “dark” or characterized by a relatively low reflectance (when compared with the unactuated state. For example, the “black state” can be the first order black with photopic brightness of <0.5%. In one example, the distance from the substrate to the movable membrane in undriven state is about 700 Å-1,300 Å. For example, the distance can be 1,000 Å.

To actuate the display element, voltage is applied between the top electrode and the movable reflective layer (which is sometimes referred to as the “mechanical layer”), and the movable reflective layer moves to a position closer to the top electrode based on electrostatic forces. When actuated, the display element reflects a certain color (e.g., blue, green or red). In some implementations, the three sub-pixels each have a different separation between the movable membrane and the top electrode to form an RGB colors respectively. In one particular implementation, the additional gaps between the movable layer and the upper electrode are about are 1000 Angstroms for first order green, 1500 Angstroms for first order red, 2200 Angstroms for first order blue.

An advantage of this implementation is that the two electrodes (one in the movable layer and the top electrode) are positioned such that light does not go through either of the electrodes in the display path. This separates the optical design and the electrical design and allows the electrodes to be optimized without changing optical properties of the display element. Such display elements can have improved fill factor by designing the undriven (or unactuated) state of the device to appear black so that the movable reflective layer does not have bending regions in the dark or black state, which change the reflection spectrum of the display element and deteriorate black state. Accordingly, the black mask size can be reduced to increase fill factor. In addition, such a display element has improved color saturation because the optical stack does not have an insulating layer that is normally present to prevent electrical contact between the movable layer and the optical stack in other MEMS (and IMOD) pixel designs. This significantly improves color saturation of the display elements. For example, with this optical stack design the primary colors are more saturated which actually allows the use of the first order “blue.”

Another feature of the implementations of this design is that the top electrodes of the display elements can have different dimensions, increasing in surface area (and/or changing shape, size) as the gap between the movable reflective layer and the top electrode increases. This can allow using the same voltage to drive pixels of different colors, which, given the different gap sizes in prior art designs, have different driving voltages. In some implementations, the movable reflective layer has the same thickness in each display element, and the area of the electrode is the largest for the blue display element (having the largest electrical gap) and the smallest for the green display element gap (having the smallest electrical gap). To configure the size or area of the electrodes, the electrodes can have various size portions removed from the center of the electrode. For example, the electrodes can have a circular-shaped portion removed from the electrode. The significant reduction in capacitance for the blue and green electrical gaps reduces the RC time constants of the scan lines, which can allow the line-time to be faster for these colors. The same capacitance reduction also improves the RC time constant of the data lines that are shared between the three colors, again relaxing the line-time requirement.

Another feature of these implementations is that the display elements can include dimples or bumps with different shapes and patterns on the top electrode surface, where the movable reflective layer may contact the top electrode, to decrease the contact area and correspondingly decrease stiction. Because the dimples/bumps are not in the optical path, stiction can be diminished without affecting optical performance. Also, because the optical and electrical terminals are separated, the top electrode can be designed with arbitrary thickness and shape for low routing resistance without affecting the mechanics and optics of the device. In this implementation, upper electrode is formed after the movable layer, and can be the last layer formed, and its structure does not affect optical properties movable layer because it is not in the optical path of the display device.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

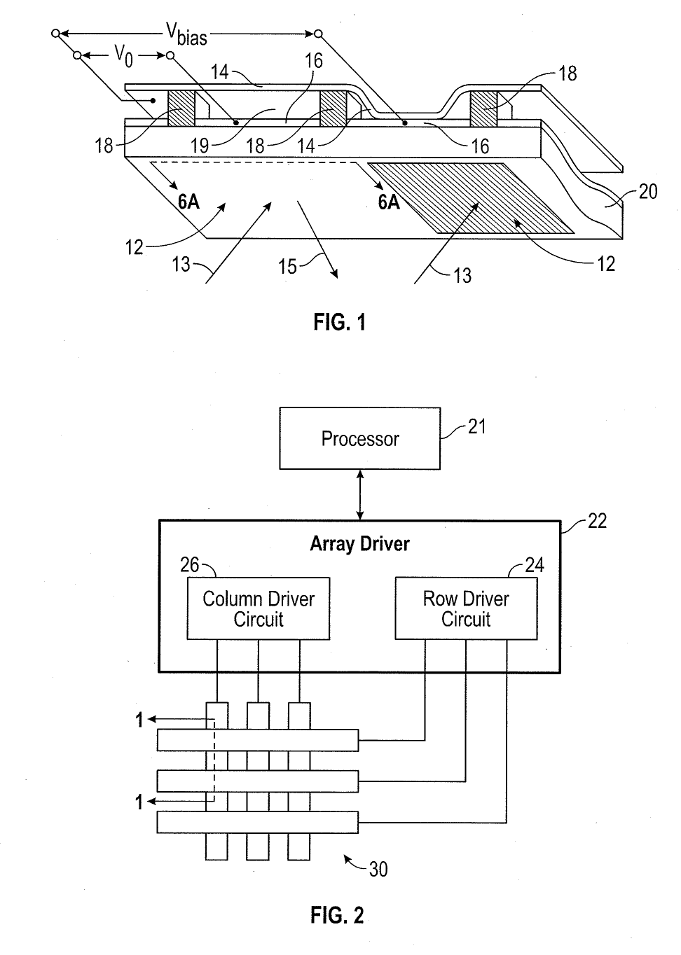

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be framed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

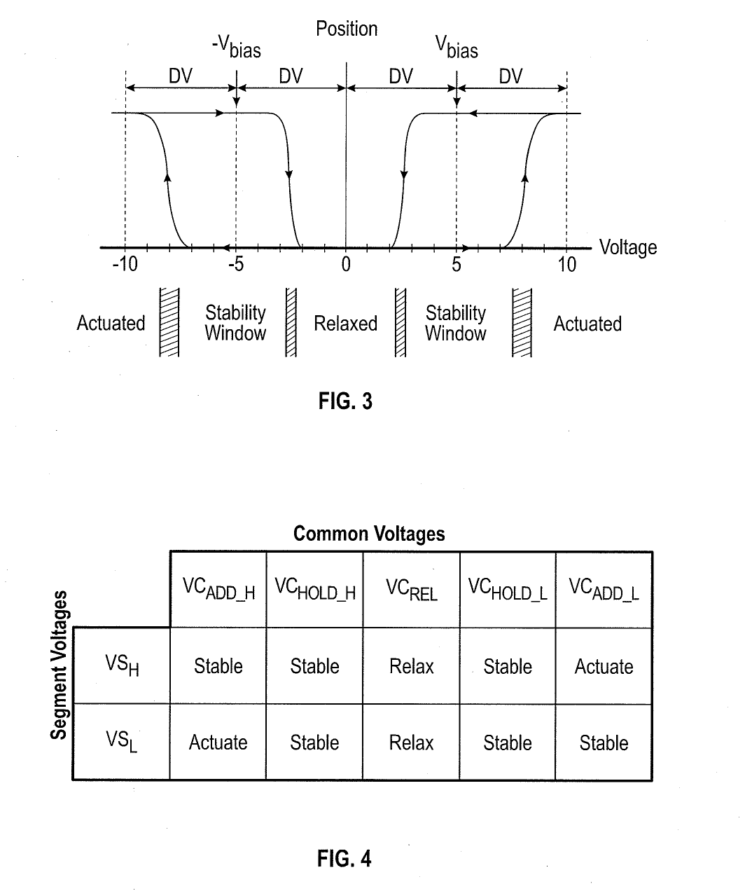

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

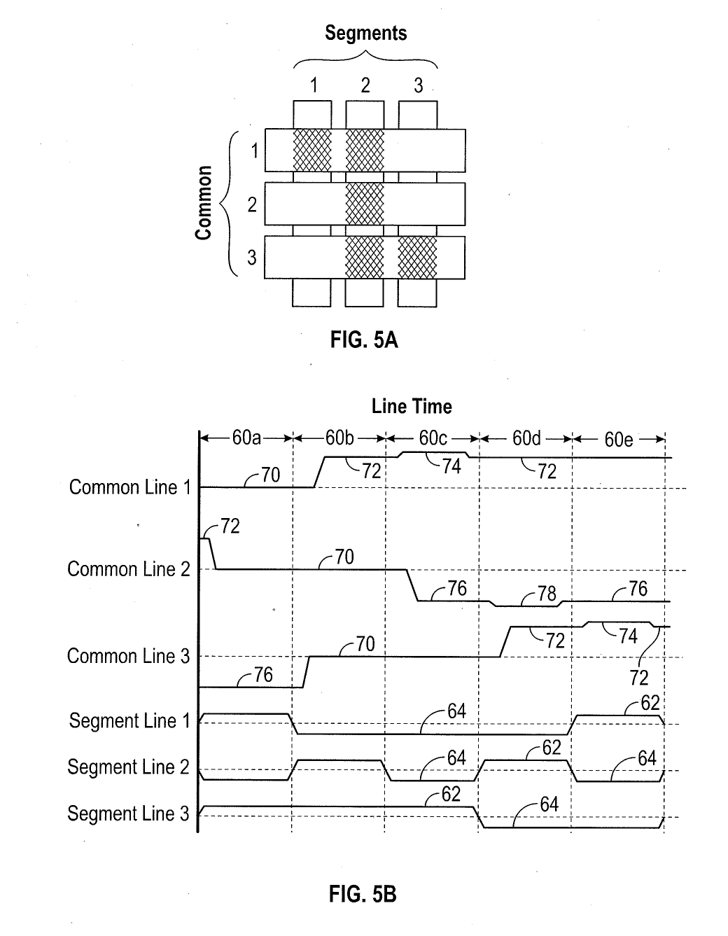

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

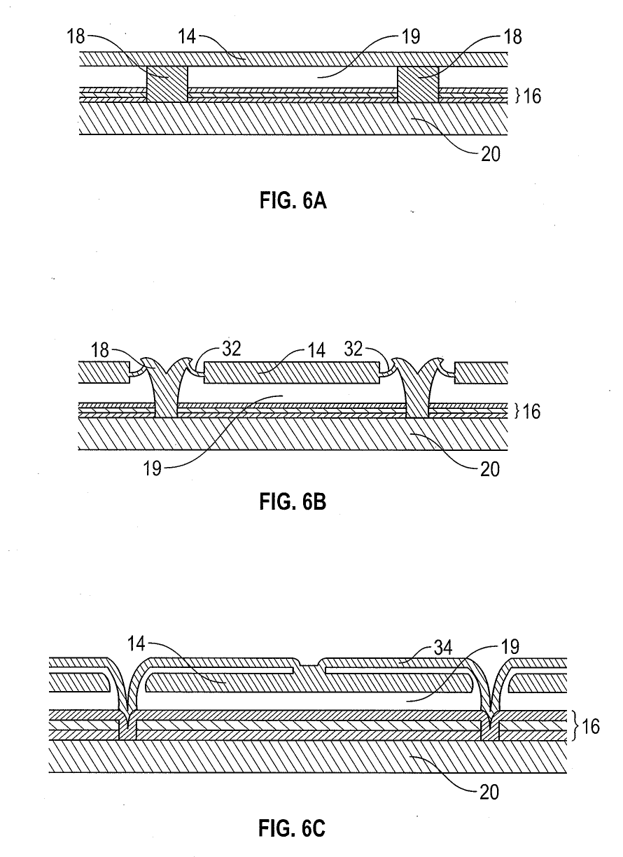

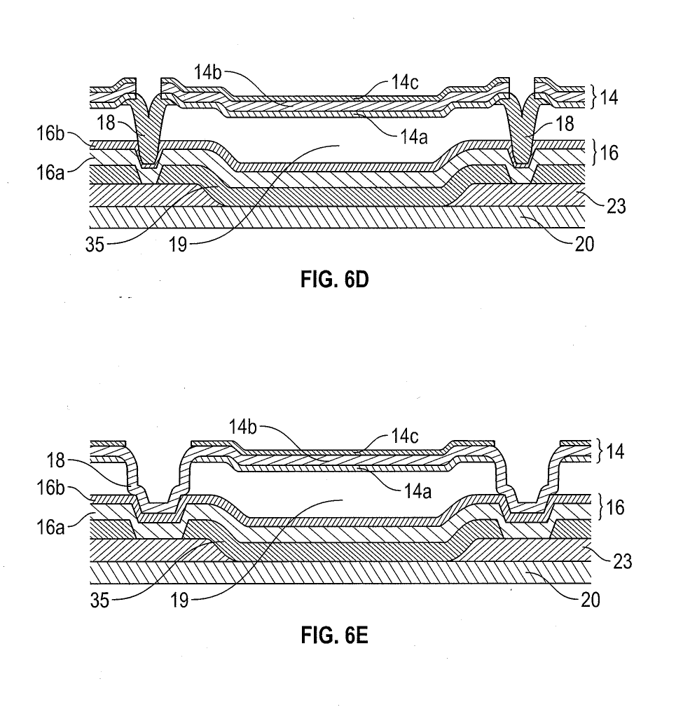

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In some implementations of interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

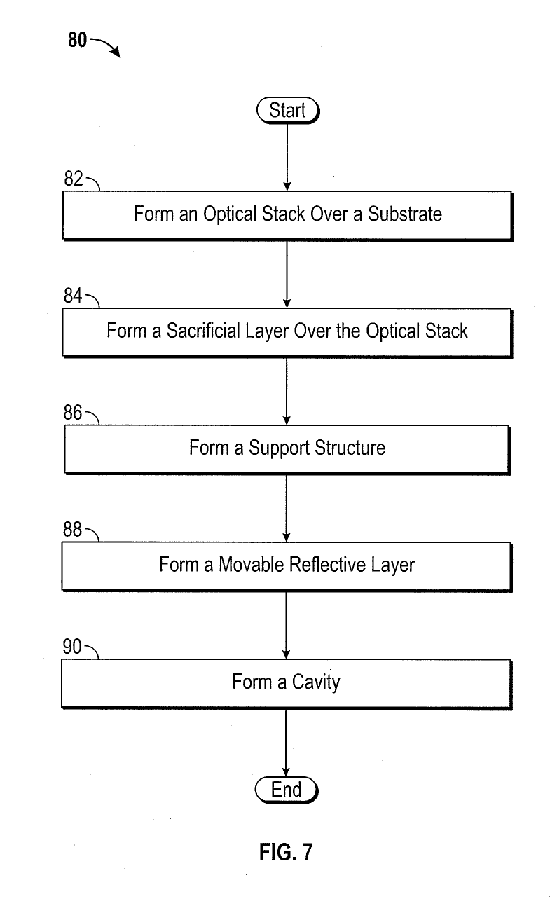

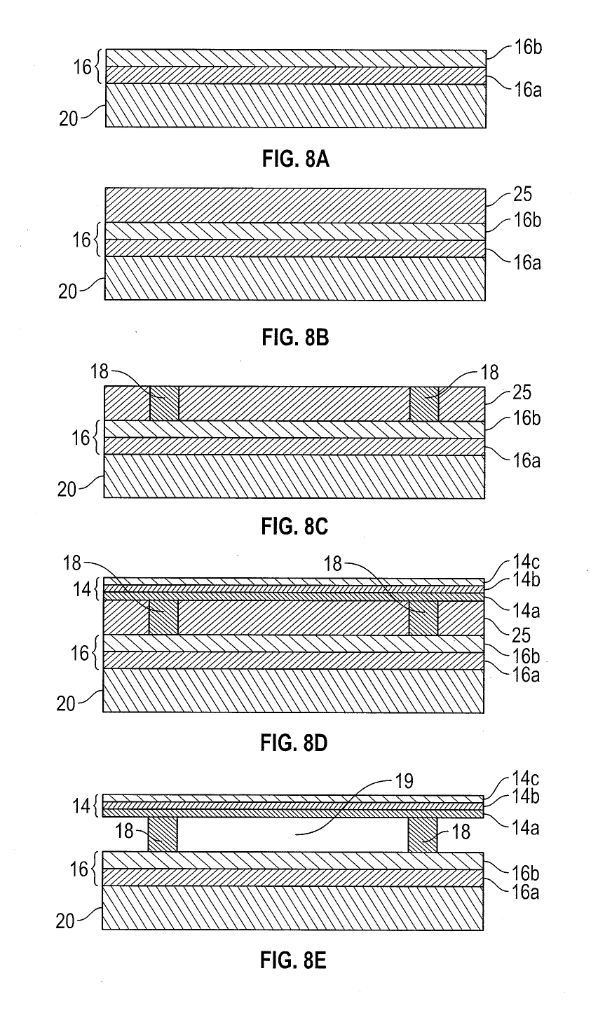

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

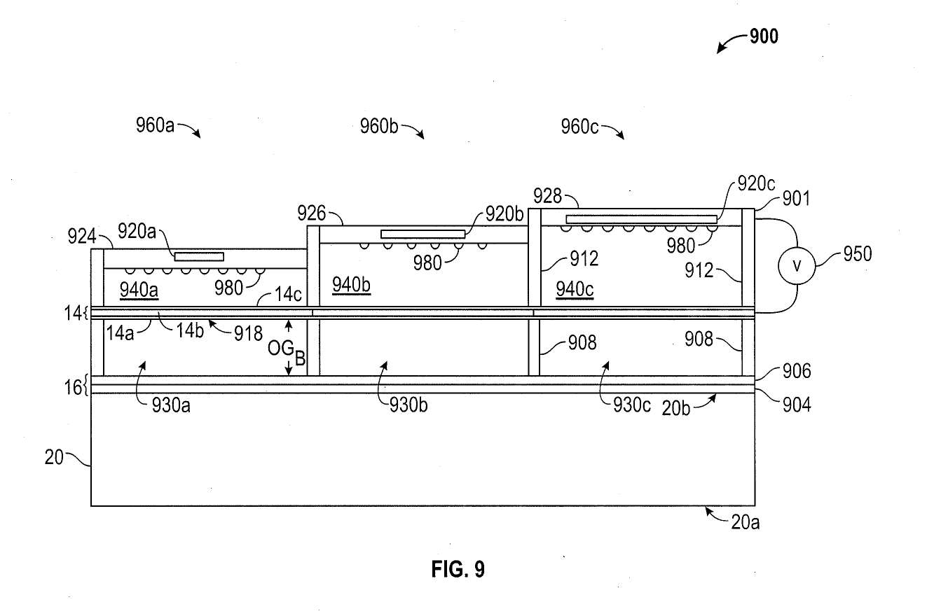

The IMOD described above in reference to FIGS. 8A-8A is a single gap interferometric modulator that actuates towards the substrate 20, however, other designs are also possible. For example, an IMOD can be configured to actuate such that the movable reflector moves in a direction away from the substrate during actuation. In such an arrangement, the IMOD may, in a relaxed position, appear dark or black (that is, having a low intensity across its reflectance spectrum). In such an arrangement, when actuated the reflector can move away from the substrate enlarging the height of the optical gap (that is, the distance between the optical stack and the reflector) and move through an electrical gap to a position to reflect a spectrum of wavelengths that appear to be a certain color. FIG. 9 shows an example of a cross-sectional schematic illustrating a portion of a display 900 that includes a pixel 901 having display elements 960 that are configured with different structural dimensions corresponding to the color of light they provide. The pixel 901 represents an implementation of one of the plurality of pixels in the display 900, and illustrates certain features. For clarity, all of the structural elements that can be in pixel 901 may not be shown. In this implementation, pixel 901 includes three interferometric display elements 960 arranged linearly (for example, in a row or column of an array of display elements), namely a blue display element 960a, a green display element 960b, and a red display element 960c. In other implementations, pixel 901 can include three display elements arranged in a different configuration, or four display elements arranged in various configurations. For pixels containing four (or more) display elements, one or more of the display elements can provide the same color, for example, green.

As illustrated in FIG. 9, the display can include a substrate 20 configured such that a user can view light provided or reflected by the display elements 960 through the substrate. In many implementations, the substrate has a planar outer surface 20a and a planar inner surface 20b. The display elements 960 are configured to receive light that is incident on the outer surface 20a and propagates through the substrate 20. The display elements 960 can then provide either reflected light of a certain color (or having a certain wavelength spectrum) out through the substrate 20, or the display elements 960 can appear “dark” (reflecting substantially no light) when viewed through the substrate 20.

FIG. 9 also shows an optical stack 16 disposed over the substrate inner surface 20b. The optical stack 16 can include an absorber layer 904 configured to partially transmit light and partially absorb light. The absorber layer 904 can include one or more of, for example, MoCr, Mo, Cr, or V. In this implementation, the absorber layer 904 is not used as a driving electrode. A thin protective layer 906 can be disposed over the absorber layer 904 to protect the absorber layer from the release etch. The absorber layer is between the substrate 20 and the protective layer 906 in this implementation. The protective layer 906 can include a thin layer of aluminum oxide (AlOx) that can have a thickness dimension of about 6 nm to about 10 nm, for example about 8 nm, in some implementations. In the implementation of FIG. 9, the substrate 20, the absorber layer 904, and the protective layer 906 all can be formed such that they form a portion of each of the display elements 960a-c of pixel 901, as well as other pixels in the array.

As shown in FIG. 9, the pixel 901 also includes a variable optical gap, for each of the display elements 960, formed between the absorber layer 904 and a movable reflector 14. In other words, blue display element 960a includes a “blue” optical gap 930a, that is, an optical gap configured to reflect blue light by having a certain height dimension as defined between the absorber layer 904 and the reflector 14 when the reflector 14 is in an actuated state. Similarly, green display element 960b includes a “green” optical gap 930b configured to reflect green light by having a certain height dimension as defined between the absorber layer 904 and the reflector 14 when the reflector 14 is in an actuated state. And red display element 960c includes a “red” optical gap 930c configured to reflect red light by having a certain height dimension as defined between the absorber layer 904 and the reflector 14 when the reflector 14 is in an actuated state. Optical gap supports 908 support the reflector 14 over the protective layer 906 at a desired height.

The reflector 14 in each display element 960a-c includes a reflective surface 918 disposed proximal to the absorber layer 904. In some implementations including the one illustrated in FIG. 9, the reflector 14 is a multi-layered structure that includes a bottom metal layer 14a having the reflective surface 918, a top metal layer 14c, and a middle dielectric layer 14b disposed between the bottom metal layer 14a and the top metal layer 14c. The top metal layer 14c of the reflector 14 is disposed distal to the absorber layer 904, and the bottom metal layer 14a is disposed proximal to the absorber layer 904. The top and bottom metal layers 14a and 14c can include aluminum (Al) or another metal. Generally the top and bottom metal layers 14a and 14c are made of the same material, or materials that have the same, or substantially the same, coefficient of thermal expansion. The reflector 14 is configured as an electrode, having the top metal layer 14c and/or the bottom metal layer 14a connected to a source 950 that provides driving signals to actuate the reflector 14. The source can be, for example a row driver circuit 24 or, more generally, array driver 22 (FIG. 2). In the implementation shown in FIG. 9, the representative source 950 is illustrated as a voltage source.

When the reflector 14 is in a released or relaxed state, as shown in FIG. 9, the reflector 14 is at a distance from the absorber layer 904 such that the optical gap 930 has a certain height dimension “OG_{B}” such that the display element 960 appears as in a dark state, for example, appears substantially black. In some implementations the dark state height dimension OG_{B} of the optical gap is between about 700 Å and 1300 Å. In such an example configuration of a dark state, about 1.5% reflection of visible light incident on the IMOD display element may be reflected (ignoring the effects of additional layers over the IMOD, such as touch screen, etc.). In some implementations the dark state height dimension OG_{B} of the optical gap is about 1000 Å. In an example configuration of a dark state, less than 0.5% reflection of visible light incident on the IMOD display elements is reflected (again, ignoring the effects of additional layers over the IMOD, such as touch screen, etc.). In the illustrated configuration and other implementations, the optical gap dark state height dimension of each of the green, red, and blue display elements 960a-c can be the same. In some implementations, the dark state height dimensions of the display elements of a pixel can range from between 90 and 130 nm. In some implementations, the difference in the optical gap of the display elements in a relaxed unactuated state can be up to about 40 nm. In some MEMS displays, such as IMOD displays, the reflector 14 is configured to actuate down towards the optical stack 16, where the actuated down state is often a dark state. As a result, the optical stack disposed on a substrate often includes additional layer of silicon dioxide (SiO₂) and an electrode formed of aluminum trioxide (Al₂O₃). The implementation illustrated in FIG. 9 does not include these two layers, resulting in better color saturation of the light reflected from the display elements 960. In addition to improved color saturation, another advantage of this configuration is its simplicity of manufacturing by requiring less dielectric layers over the optical stack 16. In contrast, the implementation illustrated in FIG. 9 is configured such that the reflector 14 actuates up towards the top electrode 920a-c.

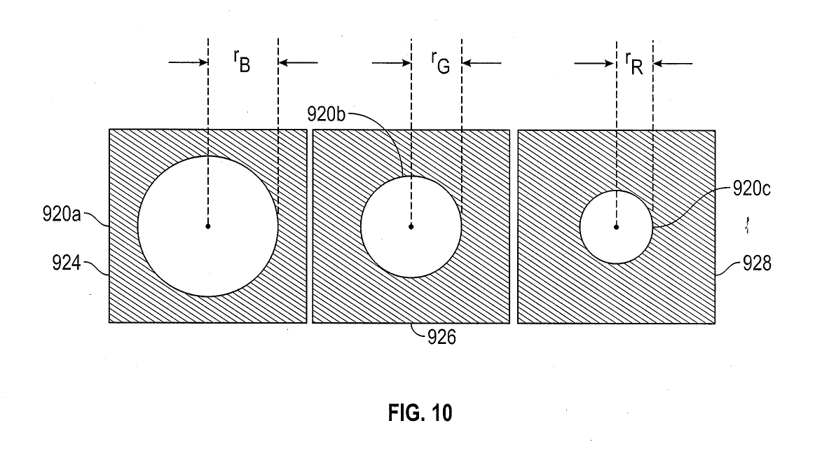

Each of the blue, green and red display element 960a-c includes an electrical gap 940a-c, respectively, defined between the reflector 14 and the top electrode layers 924, 926 and 928 of the blue, green, and red display elements 960a-c. The movable reflector 14 of each display element 960a-c is disposed between the electrical gap 940a-c and the optical gap 930a-c. Electrical gap supports 912 support the top electrode layers 924, 926 and 928 over the reflector 14 at a desired height. In the illustrated implementation, when the reflector 14 is actuated it moves away from the absorber layer 904, which increases the height dimension of the optical gap 930 and decreases the height dimension of the electrical gap 940. Accordingly, when a display element 960a-c is actuated and its movable reflector 14 moves toward the top electrode layer 924, 926 and 928 the height dimension of the resulting optical gap 930a-c formed between the reflector 14 and the absorber layer 904 places the absorber layer 904 (relatively speaking) at a minimum light intensity of standing waves resulting from interference between incident light and light reflected from the reflector 14. At this position, the absorber layer 904 absorbs many of the wavelengths of light that reflect from the movable reflector 14 and also allows some wavelengths to pass through, the light passing through the absorber giving the display element its “color” so that it appears, for example, as blue, green or red. In other words, as the absorber layer 904 absorbs a greater proportion of wavelengths of certain colors and less of others, depending on the light intensity of the standing waves at the absorber layer 904, and the wavelengths that are absorbed less propagate through the absorber layer 904 and appear as a certain color when observed by a viewer or appear as certain spectrum of wavelengths, when measured, indicative of a perceivable color. In this type of configuration, in some implementations when the display element is actuated (away from the substrate towards the top electrode 920a-c) the optical gap height dimension for a blue display element can be between about 1700 Å and 2100 Å (for example, 1950 Å), the optical gap height dimension for a green display element can be between about 2200 Å and 2700 Å(for example, 2450 Å), and the optical gap height for a red display element can be between about 2800 Å and 3400 Å (for example, 3150 Å). In some implementations, the height by the size of a “cutout” of the electrode, for example a portion of the electrode that is removed from center of the electrode. In FIG. 9 the electrodes 920a-c are illustrated as being generally rectangular or circular and having different outside dimensions. FIG. 10 illustrates rectangular-shaped electrodes dimension of the optical gaps 930a-c for each respective device 960a-c when actuated approximately equals the height dimension of the respective electrical gap 940a-c plus the OG_{B}.

The top electrode layers 924, 926, and 928 each include a top electrode 920a-c, respectively. FIG. 9 illustrates a cross-sectional view of the top electrodes 920a-c in the illustrated embodiments which are configured as having a certain size surface area. The size of the electrode surface area can be determined by the outside dimensions or overall size of the electrode, the shape of the electrode (for example, circular, square or rectangular) and/or the surface area size can be determined having a center cutout portion that is circular-shaped. The shape and the size of the top electrodes 920a-c can affect the electrostatic force that a top electrode can provide to determine actuation characteristics for the movable layer 14. When the top electrodes 920a-c are made from the same material and are disposed as layer structures of the same thickness, which may be done for ease or costs of manufacturing, the shape and size of a top electrode determines the surface area of the top electrode that is disposed proximal to the movable reflector layer 14, which in turn can determine the amount of force the top electrode can provide for a given movable reflector. Accordingly, although the top electrodes illustrated in FIGS. 9 and 10 depict two types of electrodes, other electrode structures having different shaped surface areas to affect their size are also contemplated.

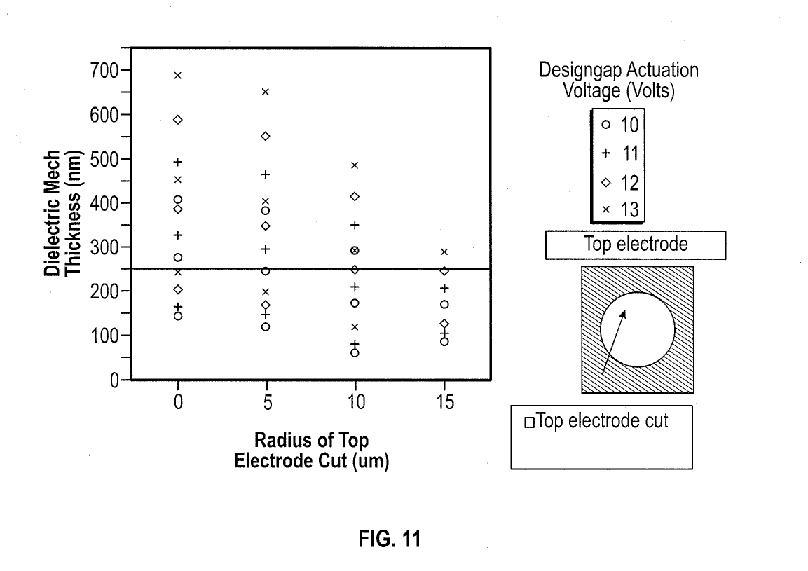

As illustrated in FIG. 9, the blue display element 960a has a top electrode 920a, the green display element 960b has a top electrode 920b, and the red display element 960c has a top electrode 920c. The surface area size of the top electrodes 920a-c are related to size of the electrical gap in the display elements 960a-c in the unactuated state. That is, as the height dimension of the electrical gap 940a-c increases the surface area of the top electrodes 920a-c may also increase to facilitate actuation. As illustrated in FIG. 9, the electrical gap 940c height dimension of the red display element 960c is larger than the electrical gap 940b height dimension of the green display element 960b. The electrical gap 940a height dimension of the blue display element 960a is smaller than the electrical gap 940b height dimension of the green display element 960b and the electrical gap 940c height dimension of the red display element 960c. In FIG. 9, the size of the top electrode is represented by 920a-c. This smaller size can be due to having smaller outer dimensions (as shown in FIG. 9) or having a larger cut-out in the electrode, as shown in FIG. 10. Accordingly, as shown in FIGS. 9 and 10, in some implementations the top electrode 920a of the blue display element 960a has a smaller surface area than the of the top electrode 920b of the green display element 960b, which has a smaller surface area than the top electrode 920c of the red display element 960c. As discussed further with reference to FIG. 11, the top electrodes 920a-c can be configured have different sizes (or surface areas) such that the display elements 960a-c all actuate at the same or similar drive voltage magnitude but due to the size differences of the top electrodes 920a-c they provide different amounts of electrostatic force, which is useful to move the reflectors 14 through the different sized electrical gaps upon actuation of the display elements 960a-c.

In this implementation, actuation of the pixel display elements 960a-c moves the reflector 14 away from the substrate and towards the top electrode layers 924, 926 and 928. In some implementations, when actuated at least a portion of the reflector 14 can be in physical contact with the top electrode layers 924, 926 and 928, and this contact can result in stiction. To mitigate or prevent stiction, one or more display elements 960a-c of the pixel 901 can include anti-stiction structures (for example, bumps or dimples) 980 disposed on the top electrode layers 924, 926 and 928 of the side proximate to the movable reflector 14. In such a configuration, a portion of the movable reflector 14 contacts the anti-stiction structures 980 when the display element is actuated. The size of the anti-stiction structures can be between about 5 nm and about 50 nm in height relative to the top electrode surface on which they are disposed. An advantage of the configuration of pixel 901 is that the anti-stiction structures are not in the optical path, but instead they are disposed in the electrical gap 940a-c and out of the optical path for the display elements 960a-c. In some implementations, at least one of the display elements 960a-c includes anti-stiction structures. In some implementations, the density of the anti-stiction structures and/or the dimensions of the anti-stiction features vary based on the size of the electrical gap 940.

Accordingly, FIG. 9, illustrates an implementation of an array having a plurality of electromechanical pixels disposed on a substrate, each pixel including at least a first display element and a second display element. FIG. 9 also illustrates means for interferometrically modulating light by moving a reflective element between a relaxed position spaced apart from the substrate by between 70 nm and 130 nm to an actuated position further away from the substrate than the relaxed position by applying a voltage across the reflective element and a stationary electrode, where the modulating light means achieves a reflective dark state when the reflective element is in the relaxed position and achieves a reflective color state when the reflective element is in the actuated position. In some MEMS displays, an optical stack disposed on a substrate includes an absorber layer (such as a partially transmissive and partially absorptive semiconductor-metal alloy that is electrically conductive and may serve as the stationary electrode) as well an additional dielectric layers such as silicon dioxide (SiO₂) and aluminum oxide (Al₂O). These dielectric layers can help to prevent shorting between the reflective element and the stationary electrode when the reflective element is actuated. However, these dielectric layers can have a negative impact on the color properties of the device. The implementation illustrated in FIG. 9 does not include these two layers, resulting in better color saturation of the light reflected from the display elements 960.

FIG. 10 shows an example of a plan view schematic illustrating different electrode dimensions for IMOD display elements in a pixel. While FIG. 9 illustrates top electrodes of different surface areas (or sizes) based on outside dimensions, FIG. 10 shows an implementation where the outside dimensions of the electrodes may be the same but the surface areas of the top electrodes are different due to a cutout in the electrodes. Although only one cutout is illustrated in the top electrodes top electrodes 920a-c, in some implementations each top electrode may have two or more cutouts that affect the surface area (or size) of the top electrode. The structures illustrated in FIG. 10 can be used in display elements of a pixel, for example, pixel 901 of FIG. 9, according to some implementations. FIG. 10 schematically depicts a portion of the top electrode layers 924, 926 and 928 for an implementation with circular-shaped cutouts for top electrodes 920a-c of a blue, green and red display element. In other implementations, it is contemplated that the top electrodes 920a-c can be configured as other various shapes, including but not limited to squares and other polygon shapes, or shapes having one or more curved edges, and have one or more cut-outs that affect their size and correspondingly the strength of the electrostatic force they provide. The cut-out radius dimensions of the top electrodes 920a-c are indicated as r_{B}, r_{G}, and r_{R}, respectively. As illustrated in FIG. 10 and further discussed in FIG. 11, the radius of each cut-out of the top electrodes 920a-c can be different which allows the top electrodes to provide different amounts of electrostatic force when an actuation voltage is applied across the movable reflector 14 (FIG. 9) and the top electrodes 920a-c.

FIG. 11 is a graph illustrating simulation results that indicate actuation voltages based on a radius of a top electrode cut and dielectric mechanical layer thickness for red, blue, and green implementations of interferometric modulator display elements. The graphical results illustrated are for implementations of display elements (for example, as shown in FIG. 9) having a top electrode layer with a circular-shaped portion of a certain radius cut out of its center. The graphed data indicates the thickness of a movable reflector (or mechanical layer) that can be moved by the various actuation voltages, for display elements that have optical gaps configured to reflect one of blue, green, or red light (when actuated away from the substrate). The radius (in microns) of the cut-out of the top electrode is shown along the X-axis, and the thickness (in nanometers) of a movable reflector is shown along the Y-axis. On the graph, a circle indicates data for an actuation voltage of 10 volts, a cross (“+”) indicates data for an actuation voltage of 11 volts, a diamond indicates data for an actuation voltage of 12 volts, and an “x” indicates data for an actuation voltage of 13 volts. The graph shows data for implementations of top electrodes having a circular cut-out, where the radius of the cut-out is 0 (no cut-out), 5, 10, or 15 microns. At each radius shown on the X-axis, from top to bottom, the top most “x”, diamond, “+,” and circle are for the blue display element, the next “x”, diamond, “+,” and circle are for the green display element, and the bottom most “x”, diamond, “+,” and circle are for the red display element. For each of the different sized cut-outs, the actuation voltage of 13 volts (indicated by the “x”) provides actuation of the thickest mechanical layer, as expected. In this example, the data indicates that the top electrodes can be configured to have different sizes so that using the same actuation voltage of 13 volts, the top electrodes of a blue, green and red display element can actuate a reflector (mechanical layer) that is about 250 nm thick (indicated by the line). In that example, as illustrated in the graph, the blue display element top electrode can have a cut-out having a radius of about 15 microns, the green display element top electrode can have a cut-out having a radius of about 10 microns, and the red display element top electrode would not have a cut-out (that is, as indicated on the graph as a cut-out having a radius of 0 microns). These simulation results indicate just one example of tuning the top electrode layers of different display elements to actuate using the same actuation voltage. Depending on the shape/size of the top electrode, the thickness of the movable reflector, and the size of the electrical gap through which the reflector must deform or move to provide an optical gap of the desired size to reflect a desired color of light, other configurations are also possible.

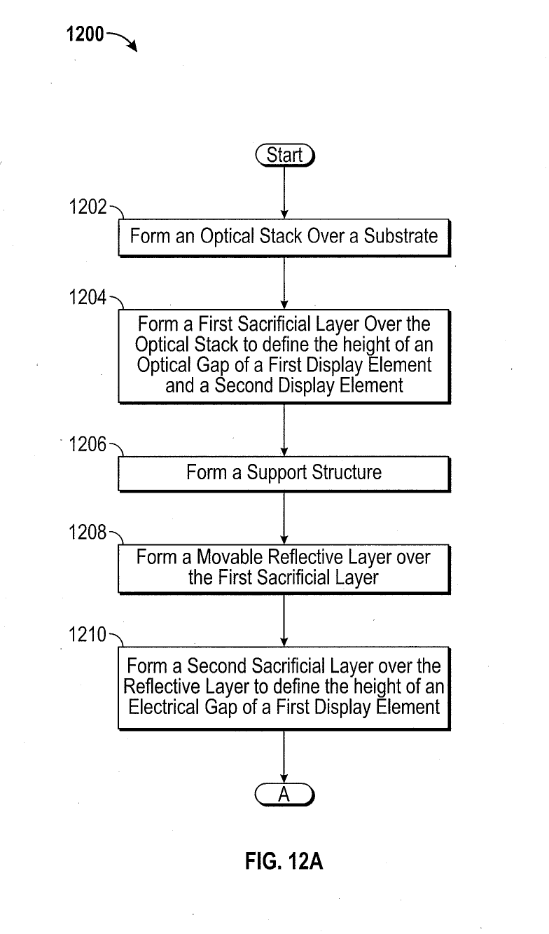

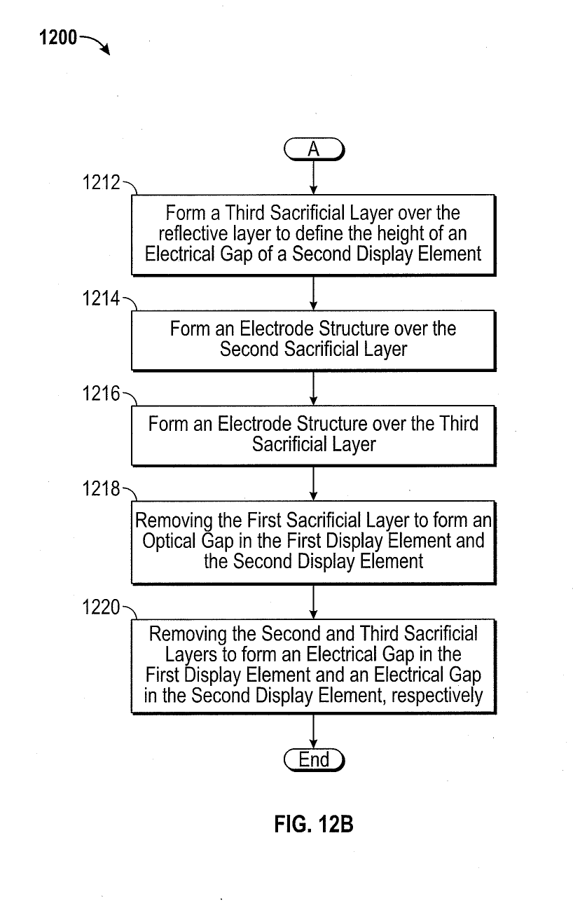

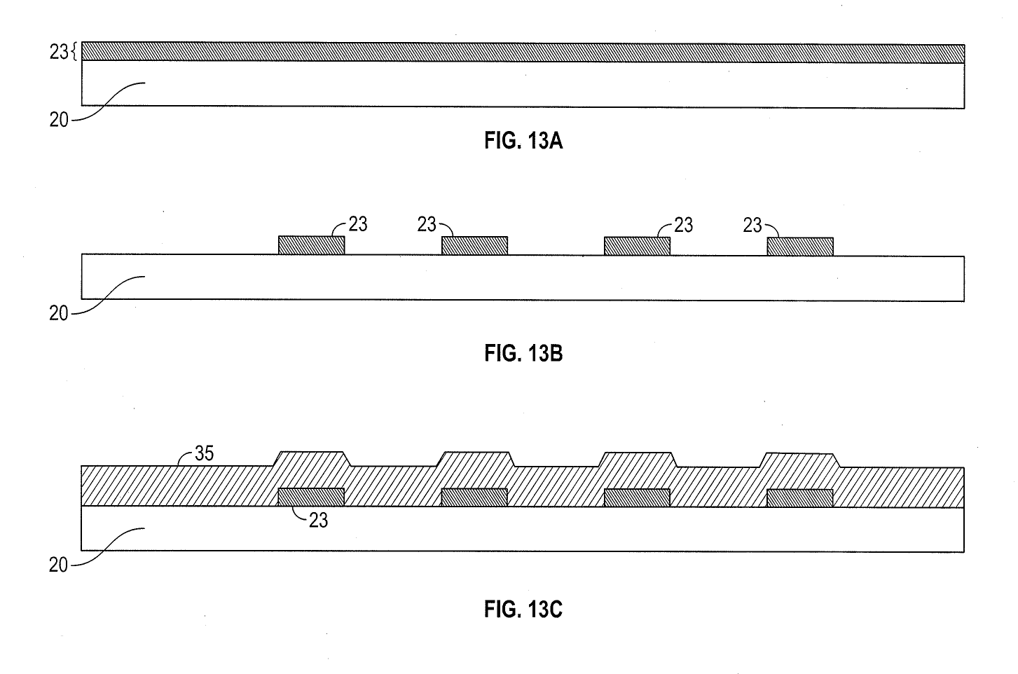

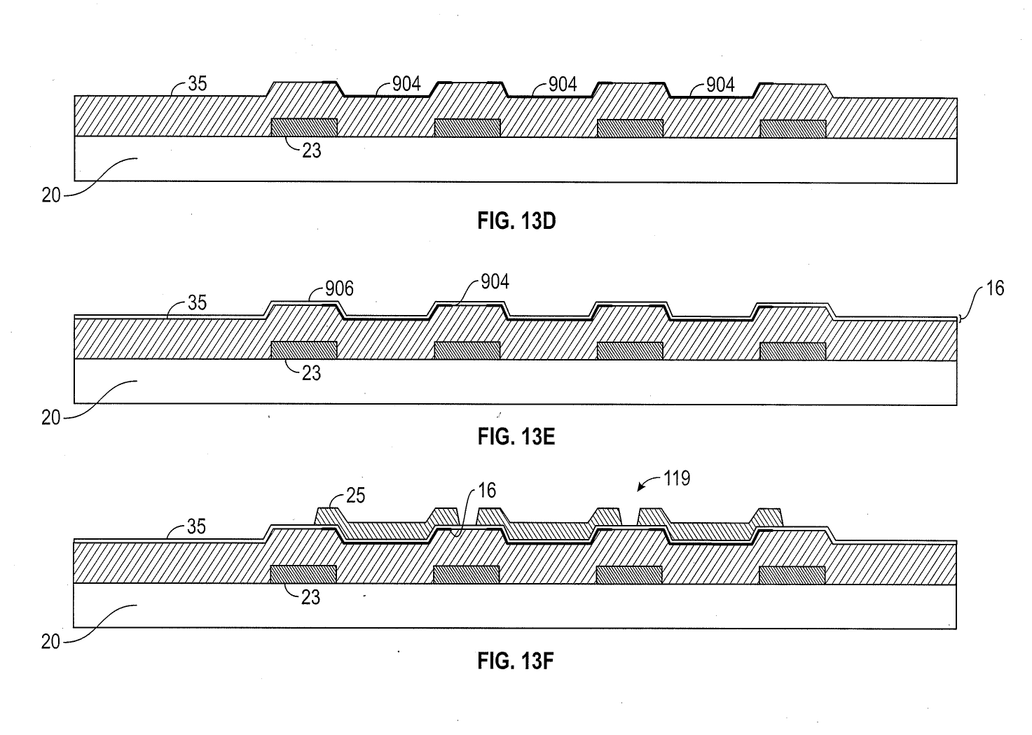

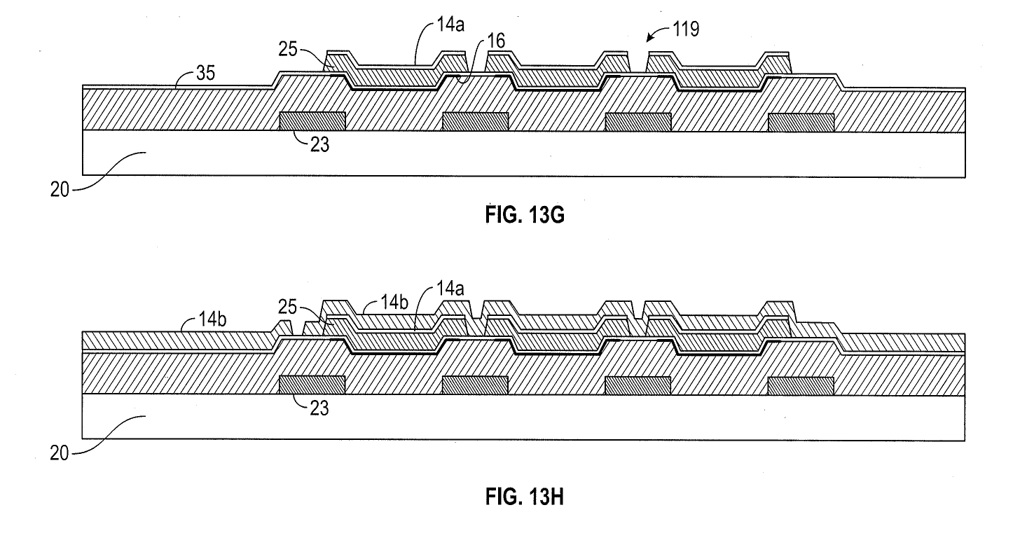

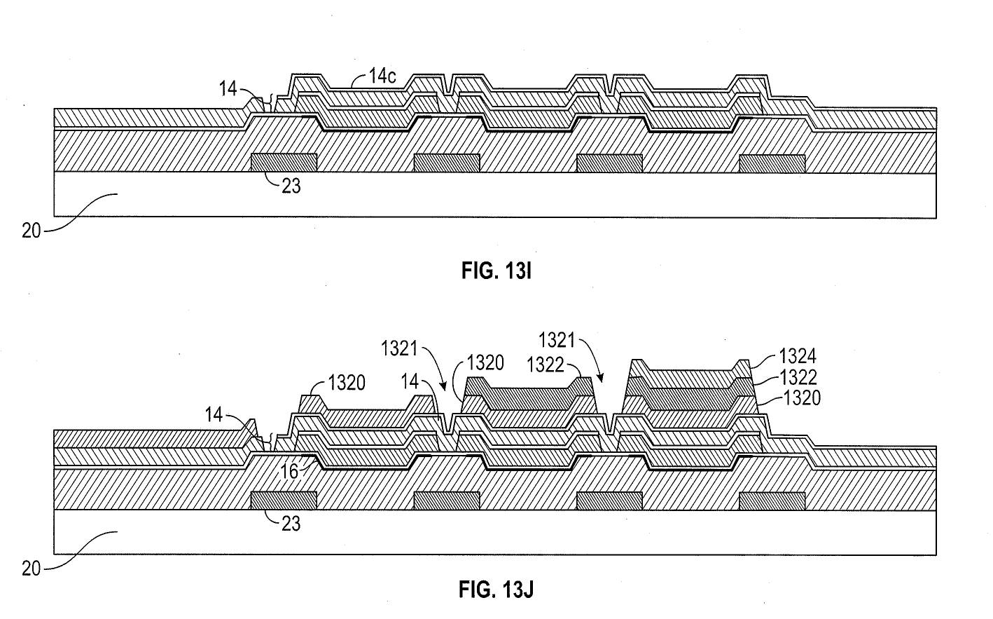

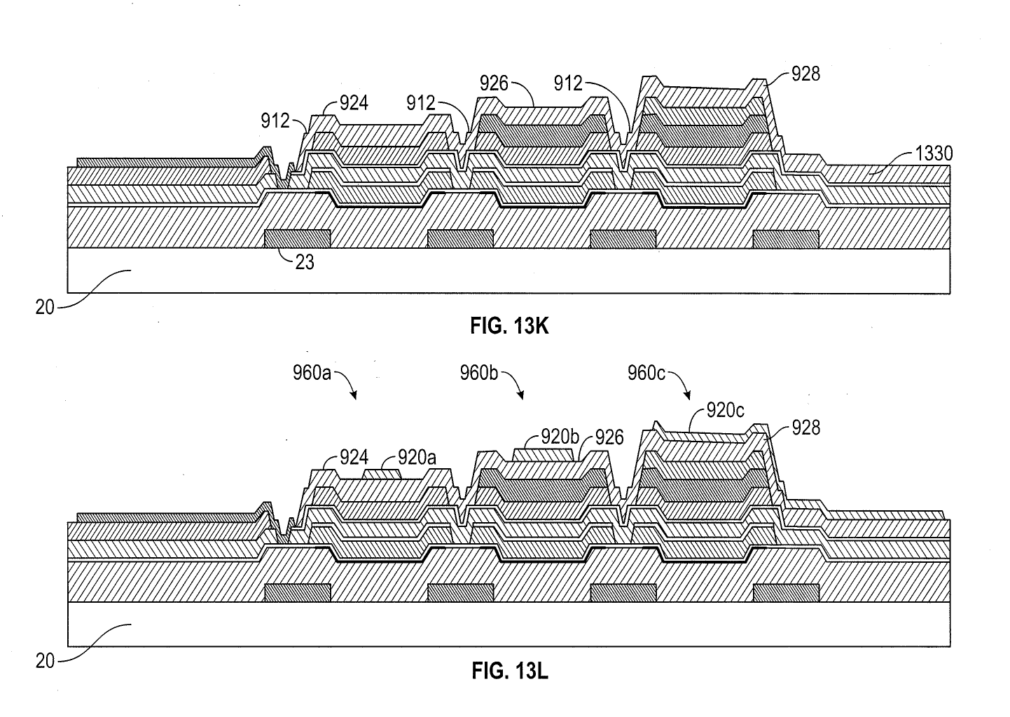

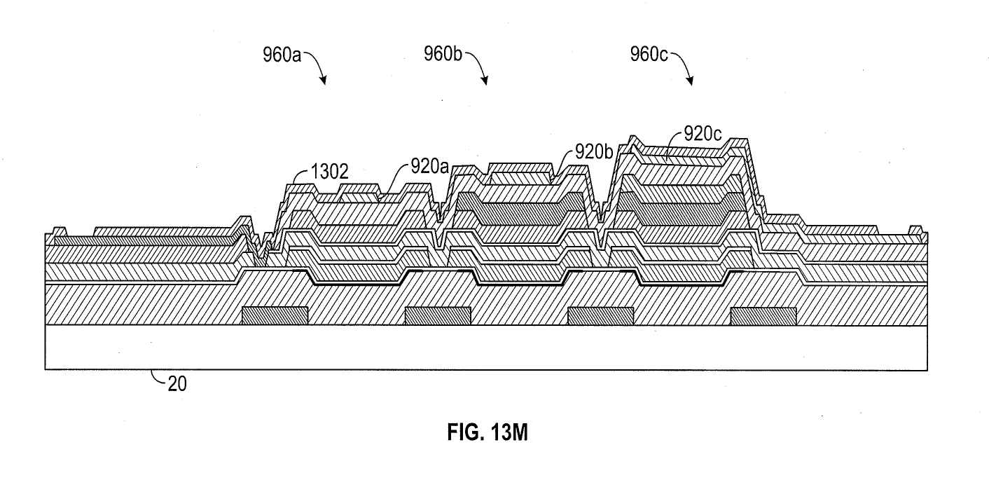

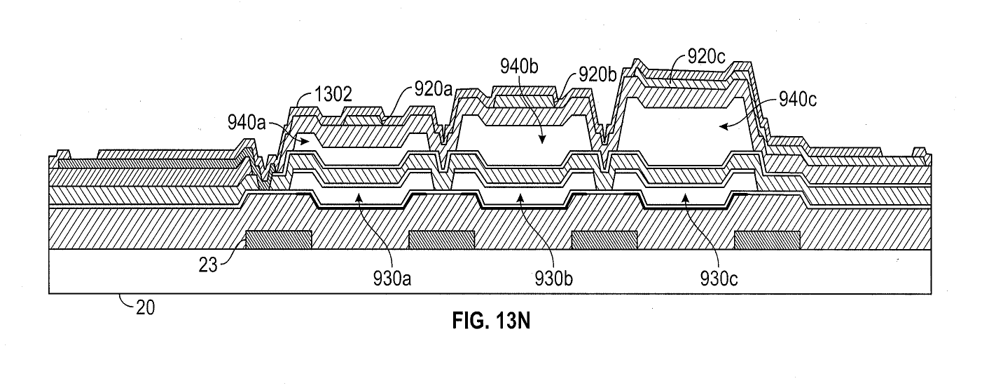

FIGS. 12A and 12B show an example of a flow diagram illustrating a manufacturing process 1200 for an interferometric modulator. FIGS. 12A and 12B are described in conjunction with FIGS. 13A-13N, which show examples of cross-sectional schematic illustrations of various stages in a process of making an interferometric modulator. While particular parts and steps are described as suitable for interferometric modulator implementations, for other electromechanical systems implementations different materials can be used or parts modified, omitted, or added. For clarity of illustrating the described implementations, the description and illustration of some features or processes may be omitted. In this implementation of process 1200, before the process described in block 1202 is performed, a substrate can be provided, a black mask structure can be formed and patterned over the substrate, and a dielectric layer can be formed over the black mask structure, as described below with reference to FIGS. 13A-13C.

In FIG. 13A, a black mask structure 23 has been provided over a substrate 20. FIG. 13A illustrates the black mask structure 23 before it has been patterned. The substrate 20 can include a variety of transparent materials, as was described above. One or more layers can be provided on the substrate before forming the black mask structure 23. For example, an etch-stop layer can be provided before depositing the black mask structure 23 to serve as an etch-stop when patterning the black mask. In one implementation, the etch-stop layer is an aluminum oxide layer (AlOₓ) having a thickness in the range of about 50-250 Å, for example, about 160 Å. The black mask structure 23 can include multiple layers to aid in absorbing light and functioning as an electrical bussing layer, as was described above. In some implementations, the black mask 23 includes a transmissive absorber layer, a reflective layer, and a dielectric layer disposed between the absorber layer and the reflective layer. The black mask structure 23 is patterned to remove portions of the black mask structure 23 that would otherwise cover the desired active areas. FIG. 13B illustrates the black mask structure 23 after it has been patterned.

FIG. 13C illustrates providing a dielectric layer 35. The dielectric layer 35 can include, for example, silicon dioxide (SiO₂), silicon oxynitride (SiON), and/or tetraethyl orthosilicate (TEOS). The dielectric layer 35 can be formed over a shaping structure (not shown) formed to have a height selected to be equal to about that of the black mask structure 23 to aid in maintaining a relatively planar profile across the substrate 20 by filling in gaps between the black mask structures 23. One or more layers, including the movable reflector layer (or mechanical layer) 14 can be subsequently deposited over such a shaping structure and any intervening layers, thereby substantially replicating the geometric features of the shaping structure. In one implementation, the thickness of the dielectric layer 35 is in the range of about 3,000-6,000 Å. However, the dielectric layer 35 can have a variety of thicknesses depending on desired optical properties.

Referring to FIG. 12A, at block 1202 an optical stack 16 is formed over the substrate (and over the black mask structure 23 and the dielectric layer 35). FIGS. 13D and 13E illustrate providing and patterning an optical stack 16. The optical stack 16 can include a plurality of layers, including an absorber layer 904 and a protective layer 906 for protecting the absorber layer 904, for example, during subsequent sacrificial layer etch and/or release processes. FIG. 13D illustrates providing and pattering the absorber layer 904. FIG. 13E illustrates providing the protective layer 906. In one implementation, the optical stack 16 includes a molybdenum-chromium (MoCr) absorber layer 904 having a thickness in the range of about 30-80 Å, and an aluminum oxide (AlOx) protective layer 906 having a thickness in the range of about 50-150 Å.

In block 1204 of FIG. 12A, a first sacrificial layer is formed over the optical stack 16 to define the height of an optical gap of a first display element and an optical gap of a second display element. In some implementations, the height of the sacrificial layer deposited in the first display element and the height of the sacrificial layer deposited in the second display element are equal or substantially equal. Accordingly, once the sacrificial layer is removed, the optical gaps of the first and second display elements will be equal, or at least substantially equal. FIG. 13F illustrates providing and patterning a sacrificial layer 25 over the optical stack 16. The sacrificial layer 25 is subsequently removed (discussed in reference to block 1218) to form gaps, in this implementation the gaps formed are optical gaps of a first display element and a second display element, as described above in reference to FIG. 9. The formation of the sacrificial layer 25 over the optical stack 16 can include a deposition step. Additionally, the sacrificial layer 25 can be selected to include more than one layer. In this implementation, the gap formed defines the (optical) gap of the dark state when the IMOD is in the relaxed or unactuated state. The device is configured such that the height of the optical gap increases when the movable reflector is actuated and moves away from the substrate, moving though the electrical gap.

At block 1206 of FIG. 12A, a support structure is formed. As illustrated in FIG. 13F, the sacrificial layer 25 can be patterned over the black mask structure 23. Subsequently deposited layers can form a support structure that holds a portion of the movable layer 14 apart from the optical stack 16 (that is, an active area portion that reflects incident light to form a portion of displayed information). In the implementation illustrated in FIGS. 13A-13N, the support structure is formed from a portion of the movable layer 14 that is disposed in a non-active area behind the black mask 23 (relative to the viewpoint of a viewer of the display element). That is, a support structure for the movable reflective layer may be formed in conjunction with forming the movable reflective layer, as discussed in reference to block 1208. The non-active or “inactive” area refers to a portion of the display that does not reflect light to provide information form the display.

At block 1208 of FIG. 12A, a reflective layer 14 is formed over the first sacrificial layer 25. As indicated above, forming the reflective layer 14 may, in some implementations, include forming a support structure. The reflective layer 14 is configured to be movable after the sacrificial layers are removed (at “release”). FIGS. 13G-13I illustrate providing and patterning a reflective layer 14 over the sacrificial layer 25. The illustrated reflective layer 14 includes a reflective or mirror layer 14a, a dielectric layer 14b, and a cap or conductive layer 14c. The reflective layer 14 has been patterned over to aid in forming columns of the pixel array. The mirror layer 14a can be any suitable reflective material, including, for example, a metal, such as an aluminum alloy. In one implementation, the mirror layer 14a includes aluminum-copper (AlCu) having copper by weight in the range of about 0.3% to 1.0%, for example, about 0.5%. The thickness of the mirror layer 14a can be any suitable thickness, such as a thickness in the range of about 200-500 Å, for example, about 300 Å.

The dielectric layer 14b can be a dielectric layer of, for example, silicon oxynitride (SiON), and the dielectric layer 14b can have any suitable thickness, such as a thickness in the range of about 500-8,000 Å. However, the thickness of the dielectric layer 14b can be selected depending on a variety of factors, including, for example, the desired stiffness of the dielectric layer 14b, which can aid in achieving the same pixel actuation voltage for different sized air-gaps (electrical gap) for color display applications.

As illustrated in FIG. 131, the cap or conductive layer 14c can be provided conformally over the dielectric layer 14b and patterned similar to the pattern of the mirror layer 14a. The conductive layer 14c can be a metallic material including, for example, the same aluminum alloy as the mirror layer 14a. In one implementation, the conductive layer 14c includes aluminum-copper (AlCu) having copper by weight in the range of about 0.3% to 1.0%, for example, about 0.5%, and the thickness of the conductive layer 14c is selected to be in the range of about 200-500 Å, for example, about 300 Å. The mirror layer 14a and the conductive layer 14c can be selected to have similar thickness and composition, thereby aiding in balancing stresses in the mechanical layer and improving mirror flatness by reducing sensitivity of gap height to temperature.

At block 1210 of FIG. 12A, a second sacrificial layer is formed over the reflective layer to define the height of an electrical gap of the first display element. At block 1212 of FIG. 12B, a third sacrificial layer is formed over the optical stack to define the height of an electrical gap of a second display element. Although this step indicates forming a sacrificial layer(s) over reflective layers to define electrical gaps of a first and second display element, the process 1200 may also include forming a sacrificial layer(s) over a reflective layer to form an electrical gap for a third display element, or for a third and fourth (or more) display elements. FIG. 13J illustrates providing and patterning a sacrificial layer 1320 over the reflective layer 14 of the blue display element (a “first display element”). FIG. 13J further illustrates providing and patterning sacrificial layers 1320 and 1322 over the reflective layer 14 of the green display element (a “second display element”), and also providing and patterning sacrificial layers 1320, 1322 and 1324 over the reflective layer 14 of a red display element. The sacrificial layers 1320, 1322 and 1324 are later removed to form electrical gaps (of varying heights) for the blue, green and red display elements 960a-c (FIG. 9). Forming the sacrificial layers 1320, 1322 and 1324 can include multiple depositions of sacrificial layers and multiple etch steps. Additionally, each of the sacrificial layers 1320, 1322 and 1324 may include more than one layers of sacrificial material. For an IMOD array, each gap size can represent a different reflected color. As illustrated in FIG. 13J, the sacrificial layers 1320, 1322 and 1324 can be patterned over the black mask structure 23 to form apertures 1321, which can aid in the formation of support structures. In some implementations it is desired to form anti-stiction structures (for example, bumps or dimples) on the surface of the top electrode layer proximate to the reflective layer 14. In such implementations, the anti-stiction structures can be formed by making the reverse of the anti-stiction structures on a topmost surface of a sacrificial layer, that is, the surface of a sacrificial layer that is farthest from the reflective layer 14, and then forming the top electrode layer over the sacrificial layer. In one implementation, a mask is formed on the sacrificial layer and then a short etch process is performed to make dimples. The mask is removed and a top electrode layer dielectric material is deposited. A metal can then be deposited to form a top electrode. In another implementation, a “dimpled” or “textured” pattern is made using a sacrificial sublayer, patterning dimples or texture on the sacrificial sublayer, and then depositing a conformal second sacrificial sublayer over the dimples (or texture) to form less prominent (smoother) dimples or texture on the second sacrificial sublayer. In this implementation, the anti-stiction structures would be transferred to the subsequently deposited dielectric layer.

At block 1214 in FIG. 12B, an electrode structure is formed over the sacrificial layer of the first display element. At block 1216 in FIG. 12B, an electrode structure is formed over the sacrificial layer of the second display element. Forming the electrode structure can include forming support structures. For example, FIG. 13K illustrates providing and patterning a support layer 1330 over the sacrificial layers 1320, 1322 and 1324 to form support structure 912. In this implementation, the support layer 1330 also forms a portion of the top electrode layers 924, 926, and 928 as previously described in reference to FIG. 9. In other words, in some implementations the top electrode layers 924, 926, and 928 can include multiple layers, including the support layer 1330. The support layer 1330 can be formed from, for example, silicon dioxide (SiO₂) and/or silicon oxynitride (SiON), and the support layer 1330 may be patterned to fours the support structure 912 and a portion of the top electrode layers 924, 926 and 928 (shown in FIG. 9) by a variety of techniques, such as using a dry etch including carbon tetrafluoromethane (CF₄) and/or oxygen (O₂). In some implementations, the support posts 912 can be positioned at corners of the display elements.

FIG. 13L illustrates providing and patterning a top electrode 920a-c that may be a part of the electrode layers 924, 926, and 928, for example, for a blue, green and red display element 960a-c as described in FIG. 9. As discussed above, the electrodes of the different display elements may have different configurations of surface areas, sizes, dimensions, differently sized or number of cutouts, and/or different shapes in various implementations, and such configurations can affect the electrostatic characteristics of the electrodes. The top electrodes 920a-c can be electrically connected to a drive circuit, which can also be connected to the reflective layer 14. Hence, the electrostatic force between top electrode 920a and a corresponding movable electrode (such as reflective layer 14) and the electrostatic force between top electrode 920b and a corresponding movable electrode may be different when a voltage is applied across the top electrodes 920a, 920b and the corresponding movable electrodes. FIG. 13M illustrates providing and patterning a passivation layer 1302 over the electrodes 920a-c, that may be a part of the top electrode layers 924, 926 and 928.

At block 1218 of FIG. 12B, the sacrificial layer is removed to form an optical gap in the first display element and an optical gap in the second display element. At block 1220 of FIG. 12B, the sacrificial layers are removed to form an electrical gap in the first display element and an electrical gap in the second display element. Referring to FIG. 13M, all of the sacrificial layers 25, 1320, 1322 and 1324 can be removed using a variety of methods, to form the optical gaps 930a-c and the electrical gaps 940a-c, as described in reference to FIG. 9. After removal of the sacrificial layers 25, 1320, 1322 and 1324, the reflective layer 14 can become displaced away from the substrate 20 by a launch height and can change shape or curvature at this point for a variety of reasons, such as residual mechanical stresses in the mirror layer 14a, the dielectric layer 14b, and/or the cap layer 14c. The cap layer 14c can aid in balancing stresses of the mirror layer 14a by providing symmetry to the reflector 14, thereby improving flatness of the reflective layer (reflector) 14 upon release. FIG. 13N is a schematic that illustrates an example of the device of FIG. 13M after the sacrificial layers are removed. In some implementations, display devices such as illustrated in FIG. 13N can be configured as multi-state devices, where each device is addressable using a switch such as a thin film transistor (TFT). For example, the display devices can further include a planarization layer over the top electrode layer(s). The planarization layer can include one or more vias that form an electrical connection to each display device. The display devices can also include TFTs, each TFT being electrically connected to a top electrode or a movable reflective layer of a display device through a via. Accordingly, in such implementations the display devices can have multiple states, each state changing the wavelength spectrum reflected from the device. In other words, such implementations can position the movable reflective layer 14 at various positions between the relaxed “dark” state and a fully actuated state where there movable reflective layer 14 is positioned close to the electrode layer.

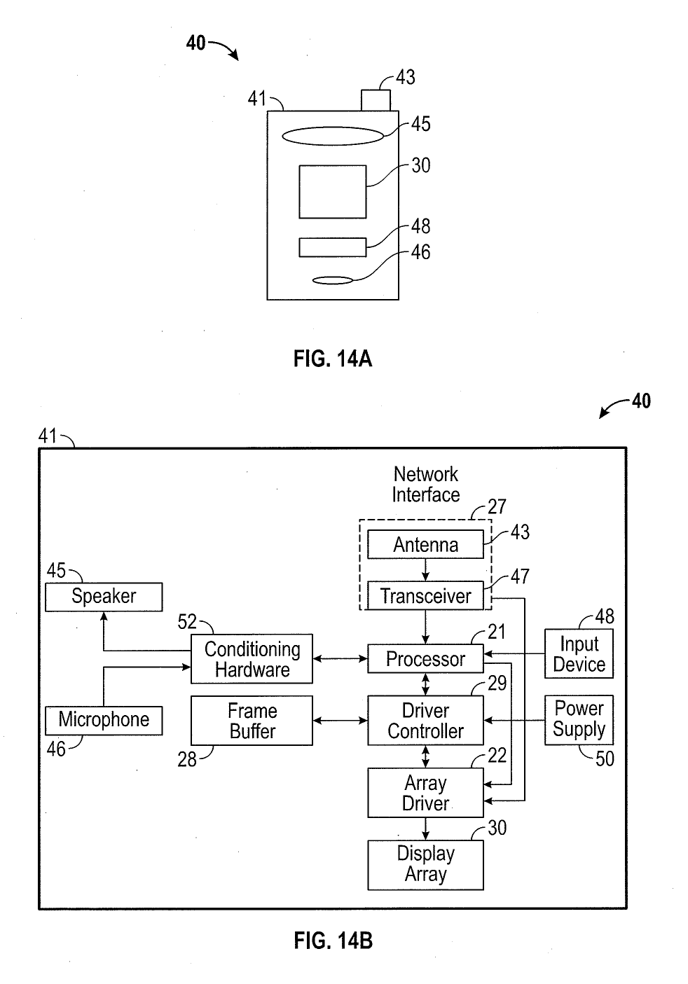

FIGS. 14A and 14B show examples of system block diagrams illustrating a display device that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. For example, display 30 can include an array of interferometric modulators as described herein in FIG. 9 and elsewhere.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays. In some implementations, the array driver can send signals for driving the display and is in electrical communication with one or both of the reflective layers (14a and/or 14c in FIG. 9) and the top electrodes (920a-c in FIG. 9) of multiple IMOD display elements.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device, comprising:
an array having a plurality of electromechanical pixels, each pixel including
a first display element having
a first optical stack including a partially transmissive absorbing layer disposed on a substrate,
a first reflective movable layer disposed over the optical stack and separated from the optical stack by an optical gap of height H₁ when the first reflective movable layer is in a relaxed state, and
a first top electrode disposed above the first movable layer and separated from the first optical stack by an electrical gap having a height H₂, the movable layer disposed between the substrate the first electrode, the first movable layer movable between a relaxed state and an actuated state by applying a voltage across the first movable layer and the first electrode; and
a second display element having
a second optical stack including a partially transmissive absorbing layer disposed on a substrate,
a second reflective movable layer disposed over the second optical stack and separated from the second optical stack by an optical gap of height H₃ when the second reflective movable layer is in a relaxed state, and
a second electrode disposed above the second movable layer and separated from the second optical stack by an electrical gap of height H₄ different than the height H₂, the second movable layer movable between a relaxed state and an actuated state by applying a voltage across the second movable layer and the second electrode.

2. The display of claim 1, wherein in the relaxed state the first movable layer achieves a reflective dark state, and wherein in the actuated state the first movable layer is moved towards the first electrode to a position to reflect light of a first spectrum of wavelengths, and wherein in the relaxed state the second movable layer achieves a reflective dark state, and wherein in the actuated state the second movable layer is moved towards the second electrode to a position to reflect a second spectrum of wavelengths.

3. The display of claim 1, wherein the first spectrum of wavelengths is different than the second spectrum of wavelengths.

4. The display of claim 1, wherein the first spectrum of wavelengths corresponds to a first color and the second spectrum of wavelengths corresponds to a second color.

5. The display device of claim 1, wherein the surface area of the first electrode is smaller than the surface area of the second electrode.

6. The display device of claim 1, wherein the height H₂ is greater than the height H₄.

7. The display device of claim 5, wherein the first electrode has a different shape than the second electrode.

8. The display device of claim 1, wherein at least a respective portion of at least one of the first and second electrodes includes anti-stiction bumps or anti-stiction dimples.

9. The display device of claim 1, wherein each of the first and second optical stacks include a light absorbing layer having a thickness dimension of less than 10 nm and an etch stop layer having a thickness of less than 10 nm, the etch stop layer being disposed between the light absorbing layer and optical gap of the first display element, and also between the light absorbing layer and the optical gap of the second display element.

10. The display device of claim 9, wherein the light absorbing layer includes molybdenum-chromium (MoCr).

11. The display device of claim 10, wherein the etch-stop layer includes aluminum oxide (AlOx).

12. The display device of claim 1, wherein heights H₁ and H₃ between about 70 nm and 130 nm.

13. The display device of claim 1, wherein the optical gap of height H₁ has a height between about 90 nm and 110 nm.

14. The display device of claim 1, further comprising
a third display element having
a third optical stack including a partially transmissive absorbing layer disposed on a substrate;
a third reflective movable layer disposed over the third optical stack and separated from the third optical stack by an optical gap of height H₅ when the third reflective movable layer is in a relaxed state;
a third electrode disposed above the third movable layer and separated from the third optical stack by an electrical gap of height H₆ which is different than the height H₂ and the height H₄, the third movable layer movable between a relaxed state and an actuated state by applying a voltage across the third movable layer and the third electrode, wherein in the relaxed state the third movable layer achieves a reflective dark state, and wherein in the actuated state the third movable layer is moved towards the third electrode to a position to reflect a third color.

15. The display device of claim 1, wherein the first and second display elements are interferometric modulators.

16. The display device of claim 1, further comprising:
a display, wherein the display includes an array of the first display element and second display element;
a processor that is configured to communicate with the display, the processor being configured to process image data; and
a memory device that is configured to communicate with the processor.

17. The display device of claim 16, further comprising a driver circuit configured to send at least one signal to the display.

18. The display device of claim 17, further comprising a controller configured to send at least a portion of the image data to the driver circuit.

19. The display device of claim 16, further comprising an image source module configured to send the image data to the processor.

20. The display device of claim 16, further comprising an input device configured to receive input data and to communicate the input data to the processor.

21. The display device of claim 1, wherein the height H₁ and the height H₃ are substantially the same.

22. A display device, comprising:
an array having a plurality of electromechanical pixels disposed on a substrate, each pixel including at least a first display element and a second display element, each of the first and second display elements including
means for interferometrically modulating light by moving a reflective element between a relaxed position spaced apart from the substrate by between 70 nm and 130 nm to an actuated position further away from an optical stack disposed on the substrate than the relaxed position by applying a voltage across the reflective element and a stationary electrode, wherein the modulating light means achieves a reflective dark state when the reflective element is in the relaxed position and achieves a reflective color state when the reflective element is in the actuated position.

23. The display device of claim 22, wherein
the first display element includes
a first optical stack including a partially transmissive absorbing layer disposed on a substrate;
a first reflective movable layer disposed over the optical stack and separated from the optical stack by an optical gap of height H₁ when the first reflective movable layer is in a relaxed state;
a first electrode disposed above the first movable layer and separated from the first optical stack by an electrical gap of height H₂, the first movable layer movable between a relaxed state and an actuated state by applying a voltage across the first movable layer and the first electrode, wherein in the relaxed state the first movable layer achieves a reflective dark state, and wherein in the actuated state the first movable layer is moved towards the first electrode to a position to reflect a first color;
wherein the second display element includes
a second optical stack including a partially transmissive absorbing layer disposed on a substrate;
a second reflective movable layer disposed over the second optical stack and separated from the second optical stack by an optical gap of height H₃ when the second reflective movable layer is in a relaxed state;
a second electrode disposed above the second movable layer and separated from the second optical stack by an electrical gap of height H₄ different than the height H₂, the second movable layer movable between a relaxed state and an actuated state by applying a voltage across the second movable layer and the second electrode, wherein in the relaxed state the second movable layer achieves a reflective dark state, and wherein in the actuated state the second movable layer is moved towards the second electrode to a position to reflect a second color.

24. The display device of claim 23, wherein at least a respective portion of the first and second electrodes includes anti-stiction bumps or anti-stiction dimples.

25. The display device of claim 23, wherein each of the first and second optical stacks include a light absorbing layer having a thickness dimension of less than 10 nm and an etch stop layer having a thickness of less than 10 nm, the etch stop layer being disposed between the light absorbing layer and the optical gap of height H₁.

26. The display device of claim 25, wherein the light absorbing layer includes molybdenum-chromium (MoCr).

27. The display device of claim 25, wherein the etch-stop layer includes aluminum oxide (AlOx).

28. A method of forming at least two display elements of a pixel of an electromechanical display apparatus, comprising:
forming an optical stack on a substrate, the optical stack including an absorbing layer having a thickness of less than 10 nm, and an etch-stop layer having a thickness of less than 10 nm;
forming a first sacrificial layer over the optical stack to define the height of an optical gap associated with a first display element and an optical gap associated with a second display element;
forming supports for a movable reflective layer;
forming a reflective layer over the first sacrificial layer;
forming a second sacrificial layer over the reflective layer to define the height of an electrical gap associated with the first display element, and forming a third sacrificial layer to define the height of an electrical gap associated with the second display element;
forming an electrode structure over the second sacrificial layer;
forming an electrode structure over the third sacrificial layer;
removing the first sacrificial layer to form the optical gap in the first display element and the optical gap in the second display element, the first and second gaps defining the position of the reflective layer of the first and second display element when the reflective layer is in a relaxed state, and
removing the second and third sacrificial layers to form the electrical gaps associated with the first and second display elements respectively.

29. The method of claim 28, wherein in the relaxed state the optical gaps have a height dimension of between 70 nm and 130 nm.

30. The method of claim 28, further comprising forming anti-stiction bumps or dimples on the electrode structure on a portion of the electrode structure proximate to the reflective element.

31. The method of claim 25, wherein the surface area of the electrode structure formed over the third sacrificial layer is larger than the surface area of the electrode structure formed over the second sacrificial layer.

32. The method of claim 31, further comprising patterning the shape of the electrode structure formed over the third sacrificial layer to be different than the shape of the electrode formed over the second sacrificial layer.
